(19) United States
(12) Patent Application Publication
(10) Pub. No.: US 2009/0123264 A1
(43) Pub. Date: May 14, 2009

(54) HANDLING DEVICE AND PROCESS FOR THE MULTIAXIAL HANDLING AND GUIDING OF WORKPIECES ARRANGED ON A CARRYING MEANS

(75) Inventors: Gerhard HARTMANN, Biberbach (DE); Juergen RADLER, Jettingen-Scheppach (DE)

Correspondence Address: MCGLEW & TUTTLE, PC, P.O. BOX 9227, SCARBOROUGH STATION, SCARBOROUGH, NY, 10510-9227, US

(73) Assignee: KUKA Systems GmbH, Augsburg (DE)

(21) Appl. No.: 11/719,435

(22) PCT Filed: Nov. 10, 2005
(86) PCT No.: PCT/EP2005/012022

§ 371 Date: May 16, 2007

(30) Foreign Application Priority Data
Nov. 17, 2004 (DE) 20 2004 017 881.8

(51) Int. Cl. B65G 61/00

(52) U.S. Cl. 414/798.2; 414/801; 414/788

(57) ABSTRACT

A method and device is provided for multiaxial handling and guiding workpieces (9), particularly vehicle body subassemblies, in a processing station (2) relative to one or more processing devices (11). The workpieces (9) are placed on a supporting device (17) and, together with the supporting device (17), are handled by a number of multiaxially moving manipulators (15, 16) in common directions that are coordinated with one another, and are guided. The workpieces (9) are received by the manipulators (15, 16) together with the supporting device (17) at a receiving area (13) and are moved to a spatially separate processing area (14) and back again, whereby they are displaced relative to one or more processing devices (11) in the processing area (14) during the processing process.

### CROSS REFERENCE TO RELATED APPLICATIONS

This application is a United States National Phase application of International Application PCT/EP2005/012022 and claims the benefit of priority under 35 U.S.C. § 119 of DE 20 2004 017 881.8 filed Nov. 17, 2004, the entire contents of which are incorporated herein by reference.

### FIELD OF THE INVENTION

The present invention pertains to a handling device and a process for the multiaxial handling of workpieces with the features in the preambles of the principal process claim and the principal device claim.

### BACKGROUND OF THE INVENTION

Such a handling device is known from practice. It comprises an individual manipulator, e.g., a multiaxial articulated-arm robot, which carries and guides a gripping means with a component held thereon. The field of use is limited to relatively small and lightweight workpieces.

### SUMMARY OF THE INVENTION

The object of the present invention is to show a handling technique that is also suitable for larger and heavier workpieces, especially vehicle body assembly units.

The present invention accomplishes this object. With the handling device and the handling process according to the invention, it is possible to handle large and heavy workpieces, especially vehicle body assembly units, by means of a carrying means, and to move them relative to one or more machining devices during the machining process. The workpiece can now be brought into different positions and orientations favorable for the process.

During fusion welding, e.g., inert gas shielded arc welding, the workpiece can be held and guided such that a so-called trough position is obtained at the welding site, which prevents the melt from flowing off. Similar advantages arise in other machining processes, e.g., bonding or sealing. The workpiece may also be turned upside down, as a result of which its underside will assume a position favorable for machining. The pasty adhesive or sealant can be applied from the top and it can be prevented from flowing off.

The carrying means has the advantage that it keeps the workpiece free from undesired stresses and deformations. When, e.g., one of the manipulators has a disturbance and stops, there is a certain response time until the manipulator responds or the other manipulators respond. The forces and motions now occurring are absorbed by the carrying means.

The multiaxially movable manipulators, preferably in the form of multiaxial articulated-arm robots, have the advantage that they can move and handle the carrying means and the workpiece together on a great variety of paths and with a great variety of positions and orientations. The manipulators move here in a correspondingly mutually coordinated manner and are actuated for this preferably by a common control or a plurality of coupled controls. The carrying and guiding forces can be introduced via docking sites at the carrying means. Operating materials, e.g., compressed air, power currents and signal currents, coolant, etc., may also be fed at these sites from the outside to the carrying means and optionally further to the workpiece. In particular, additional actuators at the carrying means can be supplied with energy and controlled via these sites.

There are various possibilities of designing the carrying means. The design as a support frame ensures especially good absorption of the forces and motions introduced from the outside in case of disturbance or even during the operation of the process and keeps the workpiece extensively free from stresses. For reasons of weight and because of the load of the manipulators, a lightweight construction is recommended. When especially heavy workpiece weights are to be handled, it is also possible, as an alternative, to use supporting beams, optionally in a multiple arrangement and in conjunction with more than two manipulators.

The handling device according to the invention has the advantage that the workpieces can always be machined in the preferred position. Furthermore, the machining area and the receiving or conveying area can be separated and spaced from one another in the machining station, which leads to advantages in terms of the contamination situation in the machining area. The receiving or conveying area is kept free from contamination or other undesired effects or effects of the machining process. The carrying means is burdened hereby, but the other parts of the material handling equipment are not. Furthermore, it is favorable concerning the risk of contamination that the machining and robot technique does not have to be placed under the workpiece any longer because of the improved handling. This is advantageous, e.g., during the welding, bonding or coating of vehicle body assembly units. The underbody portions can be machined from the top due to the improved handling, so that no splashes of metal generated during welding or splashes of material will rain down on the machining devices any longer.

Furthermore, it is favorable that due to the carrying means, the workpiece and especially a vehicle body can be easily lifted out of the carrying device and secured in case of an emergency stop. The machining process can proceed as a result in another machining station without an essential delay. It is also favorable that the work area of the manipulators is independent from the length of the workpiece or the length of the vehicle body during handling. It is favorable for this if the carrying device has sufficiently large dimensions for all types of workpieces. In addition, handling is facilitated if the docking sites are arranged on the narrow sides of the carrying means in the case of the usually elongated workpieces or vehicle bodies.

The handling technique being claimed has, furthermore, the advantage that it offers good accessibility to the machining station and also to the machining and mounting area. The platforms commonly used up to now in machining stations are dispensable. The handling technique ensures, furthermore, a greater friendliness for putting into operation and maintenance. Flexibility is also improved because free programmability of the handling motions is given, especially in the form of multiaxial articulated-arm robots, due to the manipulators.

Due to the brackets, the carrying means offers the possibility of holding the workpiece very securely and with positional accuracy. It is favorable for this if the brackets mesh with special reference points of the workpiece, e.g., the master holes of a vehicle body, with correspondingly designed pick-ups. These reference sites frequently have a mechanical reinforcement and permit the pick-up and support of the weight of the vehicle body. Pick-up and holding of the vehicle body in a positive-locking manner in all directions is also possible here by means of specially designed pick-ups, which is advantageous for overhead motions as well as pivoting motions in space of the carrying means with the vehicle body. A circumferential support frame with a free interior space has the advantage here that the underside of the workpieces is freely accessible for the most part for machining processes.

The carrying means may be flexibilized by a mobile arrangement of the brackets and adapted to different workpieces when needed. Thanks to their adjustability in one or more axes, e.g., by means of corresponding slides, the brackets can be brought into the desired position by means of an adjusting means with external or internal adjusting drives. They can be locked in this position with a blocking means. The blocking means may have an emergency control, with which the blocking means automatically releases the access and releases the brackets in their adjusting axes in case of an emergency stop and in case of failure of the energy supply. The workpiece can then be held on the carrying means freely floatingly, which is advantageously for relieving the workpiece in cases of an emergency stop.

The arrangement of a positioning means with a position pick-up has, on the one hand, the advantage that the materials handling technology for the workpiece may be relatively inaccurate, so that the position tolerances can be compensated and the workpiece can be picked up by the carrying means with positional accuracy. It is optionally possible now to align the carrying means relative to the workpiece or the workpiece relative to the carrying means. In addition, it is possible by means of the position pick-up to determine the type of the workpiece and above all the positions of the reference points intended on the workpiece for receiving the workpiece.

The present invention pertains, moreover, to a machining station and a manufacturing plant comprising a plurality of machining stations. Due to the handling technique within the machining station, the other station-bound materials handling technology and also the conveying technique within the manufacturing plant can be improved. Uncoupling of the machining stations and of the manufacturing plant from the machining cycle is possible by means of a plurality of parallel conveying lines with cross connections. The individual machining stations can be approached with the workpieces selectively, and overtaking sections and bypass sections are present. The order of the workpieces can change as a result within the manufacturing plant and the progression of machining. As a result, the machining processes may have any desired duration within the machining stations, and these durations may also differ from one station to the next. This optimizes the flexibility of the manufacturing plant, in which a great variety of types of workpieces, especially vehicle body types, can be run.

The present invention is schematically shown in examples in the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a top view of a handling device according to the invention in a machining station;

FIG. 2 is a front view of the handling device according to arrow II in FIG. 1;

FIG. 3 is a perspective view of the machining station according to FIGS. 1 and 2;

FIG. 4 is a bottom view of a frame-like carrying means according to the invention;

FIG. 5 is a side view of a frame-like carrying means according to the invention;

FIG. 6 is a top view of a frame-like carrying means according to the invention;

FIG. 7 is a perspective view of the carrying means according to FIGS. 4 through 6;

FIG. 8 is a another perspective view of the carrying means according to FIGS. 4 through 6;

FIG. 9 is a cut-away detail view of the site at which the workpiece is picked up on the carrying means;

FIG. 10 is a bottom view of a frame-like carrying means with two drive variants;

FIG. 11 is a top view of a variant of the carrying means with supporting beam;

FIG. 12 is a detail sectional view of the pick-up site at the master hole; and

FIG. 13 is a schematic view of a manufacturing plant.

### DESCRIPTION OF THE PREFERRED EMBODIMENTS

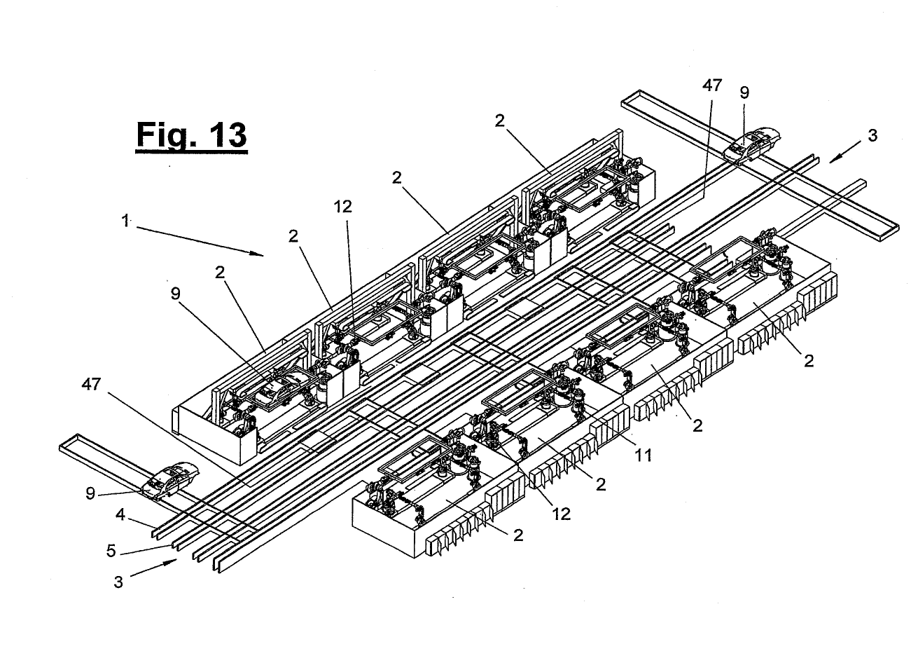

Referring to the drawings in particular, the present invention pertains to a handling device and to a process for the multiaxial handling and guiding of workpieces (9) in a machining station (2). The present invention pertains, moreover, to the design of this machining station (2) and, furthermore, to a manufacturing plant (1) comprising a plurality of machining stations (2), as it is shown as an example in FIG. 13.

The workpieces (9) may be of any desired kind and size. They may comprise any desired number of parts. In the preferred embodiment, they are assembly units of vehicle bodies. These may be complete body shells, as they are shown in the drawings. As an alternative, they may be individual vehicle body assembly units, e.g., a floor group, a body side panel or the like.

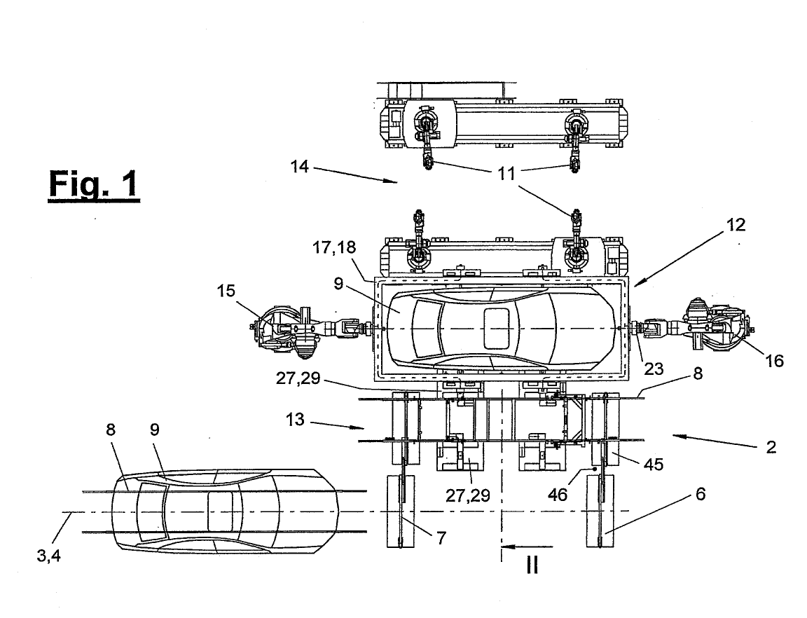

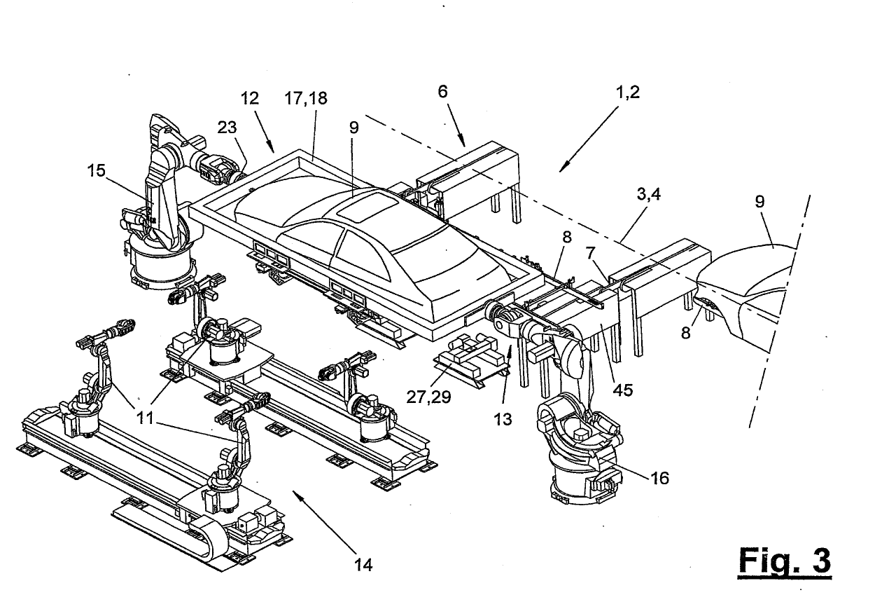

The workpieces (9) are subjected to one or more machining processes of any desired type in the machining stations (2). These may be, e.g., joining processes of various kinds, such as welding, bonding, clinching or the like. Coating processes, such as weld seam sealing, sealing, coating or the like are possible as well. At least one machining area (14) and a mounting area (13) for the workpiece (9), which are separated and spaced from one another in space, e.g., arranged next to each other, are present in the machining station (2). As an alternative, they may be arranged one on top of another. The handling device (12) explained below serves both areas (13, 14). The workpiece (9) is transported with the handling device (12) to and fro between the areas (13, 14) and, in addition, handled and guided with multiaxial motions at least in the machining area (14) in the manner favorable for the process. This handling may take place during the machining process or machining processes. The workpiece (9) is picked up in the mounting area (13) and again released after the machining. The two areas (13, 14) are located in close proximity to one another in practice. They are shown with greater mutual distances from one another in FIGS. 1 through 3 for the sake of greater clarity.

The mounting area (13) may be connected to a separate transfer site (6) of a conveying means (3). The workpieces (9), held preferably on conveying elements (8), e.g., so-called skids, can be discharged from the transfer site (6) and brought to the mounting area (13) by means of an intermediate conveyor (7). This design will be explained specifically below.

The handling device (12) comprises a plurality of multiaxially movable manipulators (15, 16), which together handle and guide a carrying means (17) with mutually coordinated motions. The workpiece (9) can be arranged on the carrying means (17), and this arrangement may be, depending on the handling kinematics, a loose placement and supporting or holding and guiding in a positive-locking manner in all directions.

The manipulators (15, 16) may have any desired, suitable design. In the exemplary embodiment that is shown and is preferred, they are multiaxial articulated-arm robots, which have, e.g., six rotatory axes. In addition, the robots may have auxiliary axes, e.g., travel axes. The manipulators (15, 16) may otherwise be designed, e.g., as linear robots with three translatory axes. To achieve the coordinated motions, the manipulators (15, 16) preferably have a common control (not shown) or, as an alternative, coupled controls.

The manipulators (15, 16) act on the carrying means (17) via suitable docking sites (23), which are arranged on at least two different sides of the carrying means (17). In the exemplary embodiment being shown, the docking sites (23) are arranged on the narrow sides of the carrying means (17) and in such a way that they are located opposite each other. The docking sites (23) are, on the one hand, mechanical connection sites between the manipulator connection, e.g., a robot hand, and the carrying means (17). In addition, connections for operating material can be created via the docking sites (23). The docking sites (23) may have any desired and suitable design. They are preferably change couplings, which make it possible to detach the carrying means (17) from the manipulators (15, 16) and to optionally replace it with another carrying means (17). A magazine (not shown) for different carrying means (17) may be present for this purpose in the machining station.

In the embodiment shown in FIGS. 1 through 3, the manipulators (15, 16) grasp the carrying means (17) with the workpiece (9) located and held thereon on the two front sides and pick up the workpieces (9) located in the mounting area (13) and optionally also on the skid (8) with the carrying means (17) by manipulator motions controlled correspondingly in a mutually coordinated manner and move it into the machining area (14). The manipulators (15, 16) move the carrying means (17) and the workpiece (9) during the machining process in a manner favorable for the process. The workpiece (9) is now optionally also tilted or turned upside down. It is held for these purposes on the carrying means (17) in a correspondingly positive-locking manner. After machining, the handling device (12) returns the workpiece (9) into the mounting area (13) and deposits it on the skid (8) which may be waiting there.

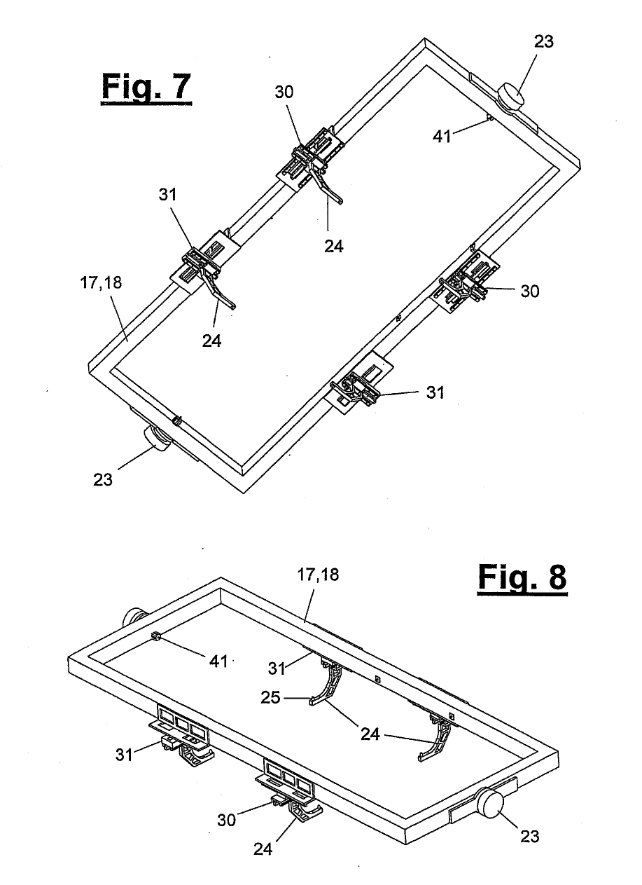

The carrying means (17) is designed as a support frame (18) in the embodiment shown in FIGS. 1 through 10. The support frame (18) is preferably of a torsionally rigid design and has a circumferential frame (19), which surrounds the workpiece (9) on the outer side and has a free space (20) located on the inside. The workpiece (9) is received in this free space (20). The support frame (18) has an essentially rectangular shape and has a docking site (23) each centrally on the two narrow sides.

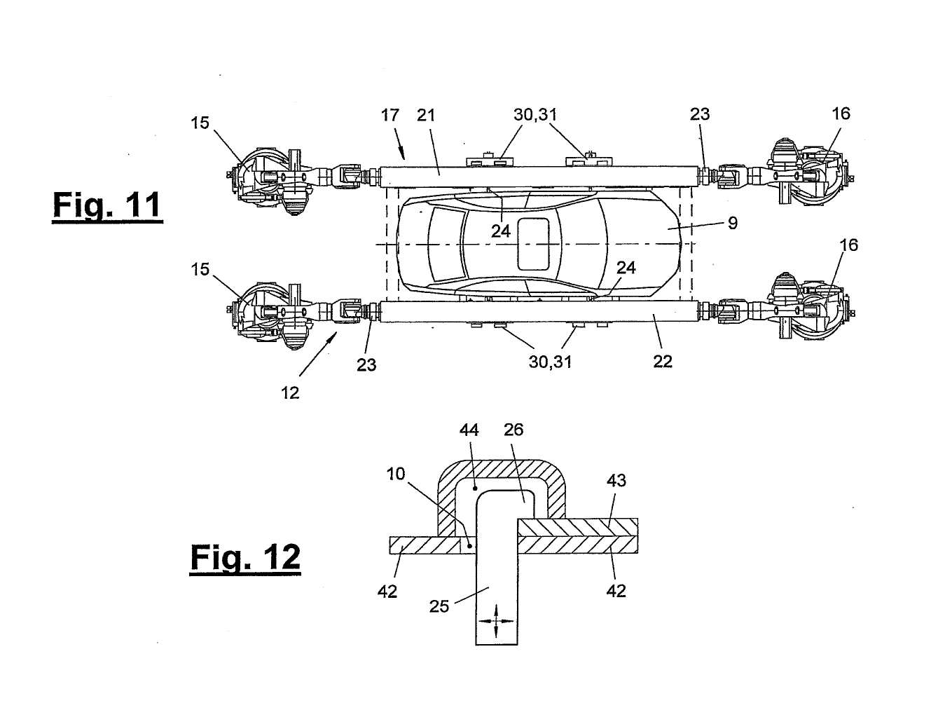

FIG. 11 shows a variant, in which the carrying means (17) comprises one or more supporting beams (21, 22), which have a docking site (23) each on the front sides for a manipulator (15, 16). For example, there are four manipulators (15, 16) in this embodiment and they move the two supporting beams (21, 22) with the workpiece (9) being held thereon together and with mutually coordinated motions. The supporting beams (21, 22) may optionally be cross-connected to one another. If, e.g., robots (15, 16) with a load of 500 kg each are used, the carrying means and the workpiece (9) together may have a weight of 2,000 kg in the embodiment shown in FIG. 11. The weight may be 1,000 kg in the variant according to FIGS. 1 through 10 with two robots (15, 16).

The carrying means (17) is of a lightweight design for maximum useful loads. The support frame (18) or the supporting beams (21, 22) preferably consist of lightweight materials, e.g., carbon fiber materials, glass fiber-reinforced plastics or the like for this purpose.

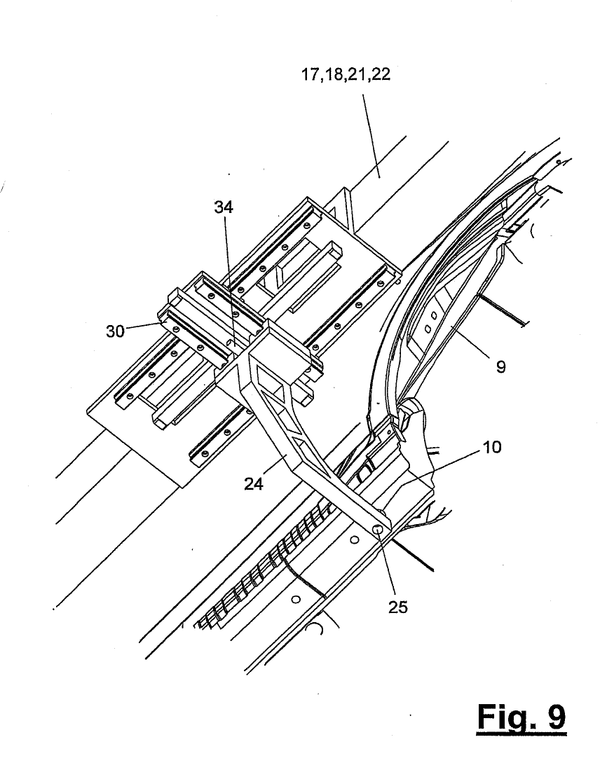

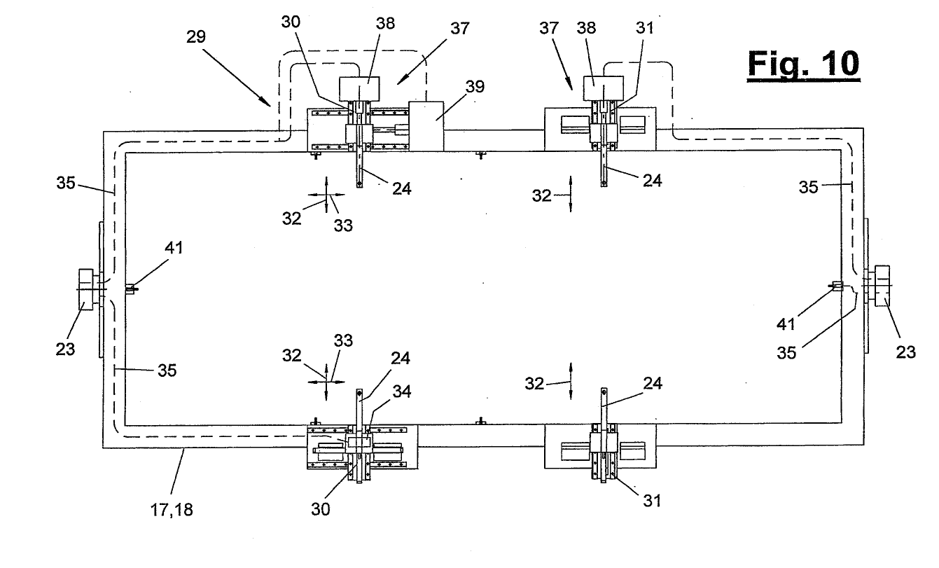

In the different variants, the carrying means (17) has a plurality of carrying elements (24) for receiving the workpieces (9), which may have any desired design and may be present in any desired number. The carrying elements (24) are designed, e.g., as brackets in the embodiments shown. The brackets (24) have a bent shape and are preferably arranged on the underside of the carrying means (17). As a result, they laterally protrude into the free space (20) of the support frame (18) or project laterally away from the supporting beams (21, 22). The brackets (24) preferably carry at their free ends at least one pick-up (25), which is adapted to a reference point (10) of the workpiece (9). The reference point (10) of the workpiece is preferably located on the underside of the workpiece and is, e.g., a master hole arranged in the underbody. FIGS. 6, 9 and 12 illustrate this arrangement. FIG. 9 shows a cut-away perspective bottom view of the lateral U-beam. In the case of a master hole, the pick-up (25) is designed as a projecting and especially upwardly projecting mandrel or pin and extends into the master hole from the bottom in a positive-locking manner.

As an alternative, master holes may be arranged laterally on the workpiece (9), in which case the brackets (24) and the pick-ups (25) have a correspondingly adapted, different arrangement and orientation. It is possible in another variant that the reference point (10) is a projection. The pick-up (25), which is complementary hereto, is a ring or another part with a receiving opening for the projection in this case.

If the workpiece (9) is moved with limited kinematics in a positionally stable alignment and is always held with non-moving center of gravity on the carrying means (17), the pick-ups (25) may have the shape of simple and essentially straight pins or mandrels. There may be a conical shape to improve the meshing with the master hole.

FIG. 12 shows another shape of the pick-up (25), which has in this case a holding element (26) for extending behind the reference point (10) at the workpiece (9) in a positive-locking manner and a corresponding auxiliary kinematics. This may be, e.g., a laterally projecting clamping dog, which comes into contact with a support reinforced with two sheet metals (42, 43) at the master hole (10) and extends behind this support in a positive-locking manner. A capsule, which covers the master hole (10) and offers a free space (44) for the immersion of the holding element (26), is present in the body at the master hole (10). A thinner body sheet metal (42) may be present on the other side of the master hole (10). With this design of the pick-up (25), the workpiece (9) can be held and guided by means of the different brackets (24) in a positive-locking manner in all directions, and tilted positions and overhead positions are possible as well.

The carrying means (17) may have, furthermore, one or more holding devices (41) for workpiece parts. These may be, e.g., mobile closing cylinders, which are arranged on the inside at the support frame (18) or at the supporting beam (21, 22) and press against the workpiece (9). FIG. 6 shows, e.g., such an arrangement in the lower half of the figure. A lateral clamping or holding force can be applied to the workpiece (9) and parts thereof with these holding devices (41), which are preferably round and are arranged distributed around the contour of the workpiece. As a result, it is possible, moreover, to compensate tolerances between pick-ups (25) and reference points (10). Furthermore, the holding devices (41) can secure and fix mobile parts at the workpiece (9), e.g., the hood or the trunk lid, at the body. The vehicle body can be held sunk in the carrying means (17) by means of the downwardly projecting brackets (24), so that the holding devices (41) can act in the correct height position. The holding devices (41) are mobile and have a corresponding operating material supply, which is established according to FIG. 10 via the docking sites (23) and corresponding lines (35) in or at the carrying means (17).

The brackets (24) may be arranged on the carrying means (17) rigidly or movably. In the exemplary embodiment shown, which is the preferred embodiment, at least some of the brackets (24) are arranged movably and have one or more adjusting axes (32, 33). The brackets (24) can be locked in the desired position by means of a blocking means (34).

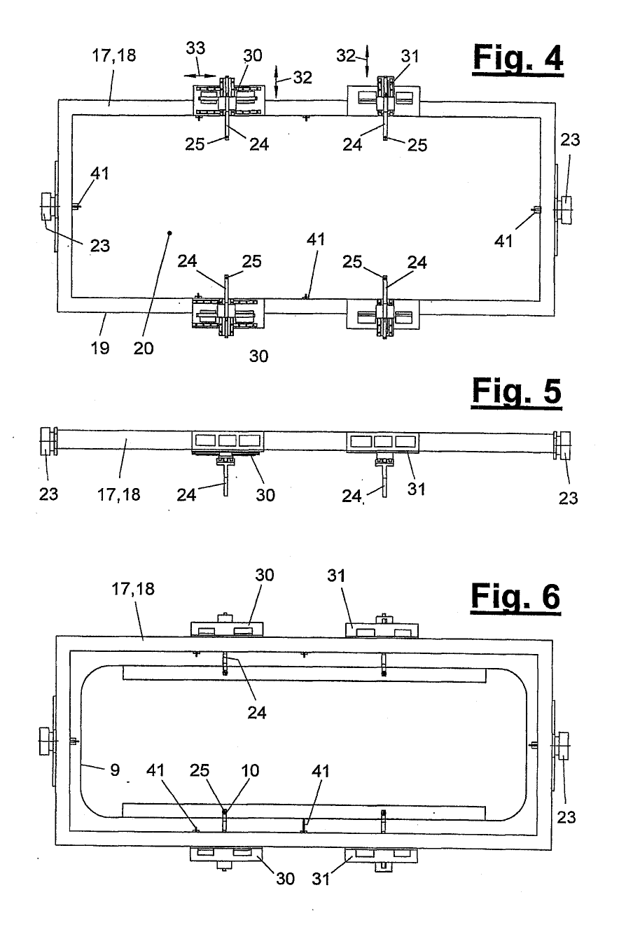

As is illustrated in FIGS. 4 through 10, the mono axial or multiaxial adjustability of the brackets (24) is brought about by means of adjusting slides (30, 31) with one or more linear adjusting axes (32, 33). The adjusting slide (30) is, e.g., a compound slide, which is arranged on the underside of the carrying means (17) and is supported at the side wall. The bracket (24) arranged at the driven-side slide element and is present as one or more brackets there can be adjusted as a result along the adjusting axis (33) in the longitudinal direction of the carrying means (17). Transverse adjustment is possible by means of the adjusting axis (32), and the bracket (24) protrudes more or less deeply into the free space (20). The slide (31) is a simple slide, which has, e.g., only the one adjusting axis (32) directed transversely. In a variant of the embodiment shown, rotatory adjusting axes may be present as an alternative or additionally. A larger number of adjusting axis may be offered as well.

The blocking means (34) can be controlled from the outside and can be detached in case of an emergency. It acts on the adjusting axes (32, 33) and the corresponding slide components. It comprises, e.g., a pneumatic clamping cylinder, which is schematically indicated in FIG. 9. The clamping cylinder is connected to a pressurized medium line (35), which is connected via the corresponding manipulator (15, 16) and is supplied from a corresponding pressurized medium source and is connected to the manipulator control. In case of an emergency, the pressure drops in the pressurized medium, and the ventilated clamping cylinder is released under the action of a counteracting spring and releases the corresponding slide component. The adjusting slide (30, 31) can be moved freely as a result, so that the workpiece (9) is held floatingly in the carrying means (17). The above-mentioned holding devices (41) can also be equipped with a corresponding emergency shut-off. In case of an emergency stop and stopping of the machining station (2), the pick-ups (25) can also be detached from the reference points (10), so that the workpiece (9) can be removed from the carrying means (17) and secured, e.g., with a crane.

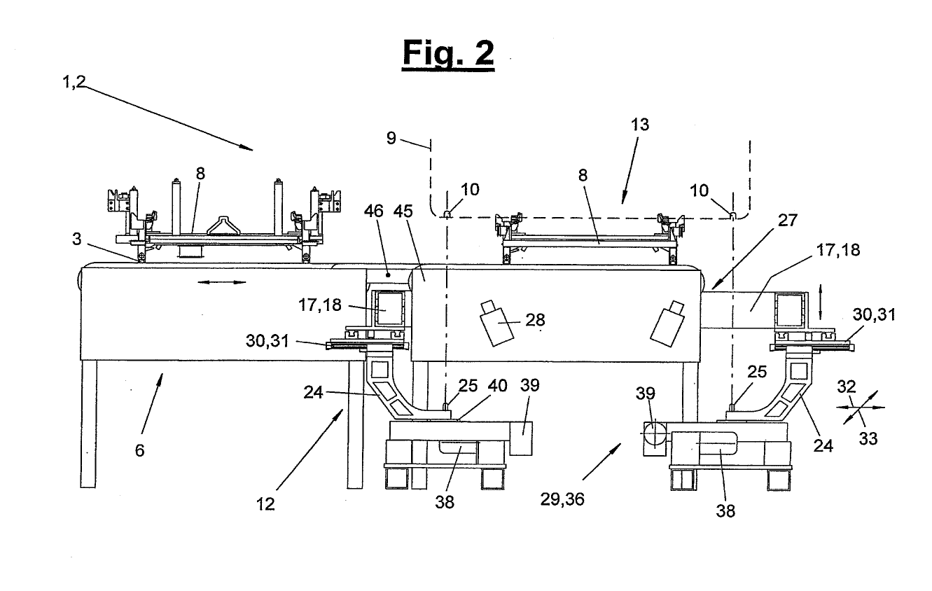

The handling device (12) and the machining station (2) have, furthermore, a positioning means (27) for the mutual positioning of the workpiece (9) and the carrying means (17). The positioning means (27) has a position pick-up (28) for this purpose for picking up the workpiece position. This may be, e.g., the camera system, which is shown in FIG. 2, is arranged under the workpiece (9) in the pick-up area (13) and with which the position and the orientation of the underside of the workpiece are picked up and measured. The positions of the reference points (10) can also be determined and measured now. As an alternative, the position pick-up (28) may have any other desired and suitable design and comprise, e.g., mechanical pick-ups or other detectors or sensors which are in contact with the component or operate in a contactless manner.

To bring the workpiece (9) and the carrying means (17) into the relative position necessary for pick-up, an adjusting means (29) is present, which is connected to the position pick-up (28) and receives from this the position and orientation information for the workpiece (9). The carrying means (17) with its brackets (24) is adapted to the workpiece (9) in the embodiment shown, the adjusting means (29) being used to adjust the positions of the brackets (24). As an alternative, the adjusting means may act on the vehicle body (9) and align same relative to the carrying means (17) and bring same into the pick-up position.

The bracket adjustment shown has the advantage that adaptation of the brackets (24) to different types of workpieces and especially different body types is also possible hereby. As a result, it is possible, e.g., to pick up underbodies of different lengths with correspondingly differently positioned reference points (10) with the same carrying means (17). Brackets (24) that may not possibly be needed can be removed or moved away, e.g., folded down.

The adjusting means (29) may optionally have an externally arranged adjusting drive (36) or an adjusting drive (37) arranged internally at the carrying means (17) for one or more brackets (24). FIGS. 1 through 9 show the variant with the external and stationary adjusting drive (36). FIG. 10 shows at a support frame (18) both variants, an internal adjusting drive (37) being shown in the top half of the figure.

As is illustrated in FIGS. 1 through 3, a support means (45), which has two front-side columns, which are located at spaced locations from one another in the longitudinal direction of the workpiece and on which the workpiece (9) can be deposited directly with its skid (8), is present at the mounting area (13). The carrying means (17) had been positioned before at the mounting area (13) in the lowered position and is located under the workpiece (9). A spaced location (46) is present for this between the support means (45) and the transfer site (6) or the conveying means (3) present there, and the part of the carrying means (17) located there can immerse through this space.

The carrying means (17) is lowered to the extent that its brackets (24) make contact with the external adjusting drive (36). This adjusting drive comprises a plurality of drive units (38, 39), which act on the brackets (24) via corresponding carriers (40) in a positive-locking manner and bring these into the position needed according to the position pick-ups (28) with the blocking means (34) released. The drive units (38, 39) may be, e.g., compound slides, with which the adjusting slides (30, 31) are moved and adjusted along their adjusting axes (32, 33). Any errors in the rotation position of the vehicle body (9) over the vertical axis are absorbed by a corresponding rotary motion of the carrying means (17). The manipulators (15, 16), which are likewise connected to the position pick-up (28) and the evaluating unit thereof, move the carrying means (17) for this purpose corresponding to the mounting area (13).

The external adjusting drive (36) relieves the carrying means (17) in terms of weight. The corresponding drive and control units may be arranged stationarily and in corresponding numbers and positions. In the variant of the internal adjusting drive (37) shown in the top part of FIG. 10, the drive units (38, 39) are located at the adjusting slides (30, 31) and the adjusting axes (32, 33). The blocking means is integrated in the drive units (38, 39) in this embodiment, so that the adjusting axes (32, 33) can likewise be released in case of an emergency stop. The drive units (38, 39) are connected via lines (35) in or at the carrying means (17) to the docking sites (23) and farther to an external operating material and signal supply unit. The external and internal adjusting drives (36, 37) may be integrated in or connected to the above-mentioned common control of the manipulators (15, 16), which is preferably also the control and evaluating means of the position pick-up (28). The drive units (38, 39) may have any desired and suitable design and be designed, e.g., as pneumatic or hydraulic drives, electric motor drives or the like.

FIG. 13 shows a manufacturing plant (1), in which a plurality of machining stations (2) are arranged in a row along a conveying means (3). The conveying means (3) may have a straight shape or a shape bent in any desired manner. It is a rail-borne conveyor for mobile conveying elements (8), especially skids, in the exemplary embodiment being shown. The skids are moved at the transfer site (6) of the individual machining stations (2) into the mounting area (13) by means of the above-mentioned intermediate conveyors (7). The intermediate conveyors (7) may be designed for this, e.g., as cross conveyors and especially as telescopic conveyors, which temporarily bridge over the above-mentioned spaced location (46) to the support means (45) and the transfer site (6) for the conveying operation and then release it again for the lifting and lowering motion of the carrying means (17). When the skid (8) is in the mounting area (13), the transfer site (6) is free, so that the next skid (8) can pass through the machining station (2).

The conveying means (3) may have a simple conveying line in the simplest form. However, two or more conveying lines (4, 5), which preferably extend in parallel and are coupled by cross connections (47), are present for the row of stations in the variant shown. Bypass sections or overtaking sections can be created by means of the cross connections. A transfer site (6) that is just blocked can be bypassed as a result by other conveying elements (8) and workpieces (9). All machining stations (2) can be approached selectively and directly due to this materials handling technology. The machining processes in the individual machining stations (2) may have, moreover, different cycle times, and the materials handling technology is made independent from the cycle times. Due to this uncoupling, the machining stations (2) can be utilized to the maximum. In addition, disturbances affect only the individual machining station (2) and do not lead to stopping of the entire manufacturing plant. In case of failure of one machining station (2), other stations (2) can take over the machining processes of those stations. The machining stations (2) are equipped for this correspondingly in terms of machinery and devices and have control programs that can be switched over correspondingly.

FIG. 13 shows, in addition, the variant in which two lines of a plurality of machining stations each, arranged one after another in a row, are present. Highly complex machining of the workpiece (9) and especially vehicle body assembly units can take place as a result in the shortest space possible and with a highly flexible materials handling technology.

Various variants of the embodiments shown are possible. This applies, on the one hand, to the number and the arrangement as well as to the design of the manipulators (15, 16). Furthermore, the carrying means (17) may be modified beyond the variants shown. The carrying means (17) may have, e.g., other carrying elements instead of the brackets (24) shown and act on other sites of the workpiece, e.g., the roof area of a body shell. Two or more manipulators (15, 16) may optionally act together diagonally on a carrying means and handle and guide same. The manipulators (15, 16) are arranged upright in the embodiments shown. As an alternative, they may be arranged suspended on a portal or on a wall. In addition, the materials handling technology is variable as well. The mounting area (13) may be integrated, e.g., in the conveying means (3), as a result of which the transfer site (6) and the intermediate conveyor (7) are eliminated. Design changes are possible in the positioning means (27) and the components thereof, especially in the adjusting means (29) and the adjusting drives (36, 37).

While specific embodiments of the invention have been shown and described in detail to illustrate the application of the principles of the invention, it will be understood that the invention may be embodied otherwise without departing from such principles.

1. A process for the multiaxial handling and guiding of body assembly unit workpieces, in a machining station relative to one or more machining devices, the process comprising:
providing a carrying means;
arranging one or more of the workpieces on the carrying means; and
using a plurality multiaxially movable manipulators for together holding said carrying means such that said workpieces are handled and guided by common, consecutive motions together with said carrying means by said plurality of said multiaxially movable manipulators.

2. A process in accordance with claim 1, wherein said workpieces are picked up at a mounting area by said manipulators with said carrying means and are transported to a machining area arranged separated in space from said mounting area are moved back to said mounting area.

3. A process in accordance with claim 2, wherein said workpieces are moved by said manipulators with said carrying means in said machining area during the machining process relative to one or more said machining devices.

4. A process in accordance with claim 2, wherein said workpieces are rotated and turned for machining lower parts, the machining being carried out essentially from the top.

5. A handling device for the multiaxial handling and guiding of said workpieces vehicle body assembly units, in a machining station relative to one or more said machining devices, said handling device comprising:
a plurality of multiaxially movable manipulators;
a carrying means to support said workpiece thereon, said plurality of multiaxially movable manipulators handle and guide said carrying means with said workpiece arranged thereon, together and by mutually coordinated motions.

6. A handling device in accordance with claim 5, wherein said manipulators have a common control or coupled controls.

7. A handling device in accordance with claim 6, wherein said manipulators are designed as multiaxial articulated-arm robots.

8. A handling device in accordance with claim 5, wherein said carrying means has a docking site for connection to a manipulator on at least two different sides.

9. A handling device in accordance with claim 5, wherein said carrying means comprises a support frame.

10. A handling device in accordance with claim 9, wherein said support frame has a circumferential frame surrounding said workpiece on the outside with a free space located on the inside of said circumferential frame.

11. A handling device in accordance with claim 9, wherein said support frame has an essentially rectangular shape, a docking site being arranged centrally on each of two narrow sides.

12. A handling device in accordance with claim 8, wherein said carrying means comprises one or more supporting beams, which have docking sites for two said manipulators on the front sides thereof.

13. A handling device in accordance with claim 5, wherein said carrying means has a lightweight design and consists of lightweight materials comprising one or more of carbon fiber materials, and glass fiber-reinforced plastics.

14. A handling device in accordance with claim 5, wherein said carrying means has a plurality of brackets with at least one said pick-up adapted to a reference point of said workpiece.

15. A handling device in accordance with claim 14, wherein said pick-up is designed as a projecting mandrel or pin for cooperation with a master hole on said workpiece.

16. A handling device in accordance with claim 14, wherein said pick-up has a holding element for extending behind said reference point on said workpiece in a positive-locking manner.

17. A handling device in accordance with one of the above claims claim 14, wherein said brackets have a bent shape and are arranged on the underside of said carrying means.

18. A handling device in accordance with claim 14, wherein carrying means comprises a support frame defining a free space and said brackets extend into said free space of said support frame.

19. A handling device in accordance with one of the above claims claim 5, wherein said carrying means has one or more holding devices for holding workpiece parts or holding a portion of the workpiece.

20. A handling device in accordance with claim 14, further comprising a positioning means for mutually positioning said workpiece and said carrying means.

21. A handling device in accordance with claim 20, wherein said positioning means has a position pick-up for detecting the workpiece position.

22. A handling device in accordance with one of the above claims claim 21, wherein said positioning means has a adjusting means (29) for adjusting the position of said brackets.

23. A handling device in accordance with claim 22, wherein said adjusting means is connected to said position pick-up.

24. A handling device in accordance with claim 14, wherein said brackets are arranged such that they are movable along one or more axes and can be locked at said carrying means.

25. A handling device in accordance with claim 24, wherein said brackets have a adjusting slide with one or more said adjusting axes.

26. A handling device in accordance with claim 25, wherein said adjusting slide has a controllable and releasable blocking means.

27. A handling device in accordance with claim 23, wherein said adjusting means has a externally arranged adjusting drive or an adjusting drive arranged internally at said carrying means for one or more said brackets.

28. A handling device in accordance with claim 5, wherein said carrying means has one or more said lines connected to a docking site for operating material and signal supply for said blocking means and/or for said adjusting drive.

29. A machining station comprising: comprising:
a machining station with a machining device;
a mounting area connected to a conveying means; and
a handling device, wherein said machining station has a machining area with said machining device and said mounting area connected to said conveying means receives said workpieces, wherein said handling device serves both said machining area and said mounting area, said handling device comprising:
a plurality of multiaxially movable manipulators;
a carrying means to support said workpiece thereon, said plurality of multiaxially movable manipulators for handling and guiding said carrying means together with said workpiece arranged and supported thereon by mutually coordinated motions of said plurality of multiaxially movable manipulators.

30. A machining station in accordance with claim 29, wherein said conveying means has one or more mobile conveying elements for receiving said workpieces.

31. A machining station in accordance with claim 29, wherein said conveying means has a transfer site for said workpieces, wherein said mounting area is arranged next to said transfer site and is connected to same via an intermediate conveyor.

32. A machining station in accordance with claim 31, further comprising a support means for said workpiece or said conveying element, which is arranged at a spaced location from said transfer site and has a shape compatible with said carrying means for handling, is arranged in said mounting area, said intermediate conveyor (7) temporarily bridging over said space (46).

33. A manufacturing plant with a plurality of said machining stations in accordance with claim 29, wherein a plurality of said machining stations are arranged in a row and have said conveying means as a common conveying means including a plurality of parallel conveying lines with cross connections station by station.
